(19) United States
(12) Patent Application Publication
(10) Pub. No.: US 2013/0326046 A1
(43) Pub. Date: Dec. 5, 2013

(54) SYSTEMS, METHODS AND MEDIA FOR PROVIDING CLIENT-SIDE INTERPORTLET COMMUNICATION

(71) Applicants: Aston CHAN, Merrimack, NH (US); James ARSENAULT, Amherst, NH (US); Shah Tejashkumar PRAKASHCHANDRA, Secunderabad (IN)

(72) Inventors: Aston CHAN, Merrimack, NH (US); James ARSENAULT, Amherst, NH (US); Shah Tejashkumar PRAKASHCHANDRA, Secunderabad (IN)

(73) Assignee: Progress Software Corp., Bedford, MA (US)

(21) Appl. No.: 13/483,220

(22) Filed: May 30, 2012

(51) Int. Cl. G06F 15/173

(52) U.S. Cl. 709/224

(57) ABSTRACT

A method for providing client-side interportlet communication includes: executing an even manager, generated at a portal server, on a client device hosting a portal page for providing interportlet communication to portlets contained in the portal page; receiving at the event manager running on a client device a registration request from each of the portlets when the portal page containing the portlets is loaded; and receiving at the event manager an event set off by one of the portlets wherein the event is defined by a token published by the one of the portlets. If the token defining the event matches the published token defined in a behavior of the portal page, the method also includes invoking at the event manager callback functions of one or more of the portlets having at least one subscription token that matches the corresponding subscribed token defined in the behavior.

### BACKGROUND

A web portal application allows users to create one or more portal pages containing multiple pieces of information, or content, that are often referred to as portlets. For example, a user may create a portal page showing two portlets, in which one portlet displays the map of a geographical area (e.g., city, county, state, etc.) and the other portlet displays the weather forecasts for the selected geographic area. When a user interacts with one portlet, it is often a required functionality that the information selected or specified in that portlet affects the information displayed by other portlets available in the same or a different portal page. For instance, the user with the map and weather forecast portlets would probably like to see that updating the geographic area displayed in the map window automatically updates the weather forecasts information displayed in the forecast window, and vice versa. This is sometimes referred to as a “drill-down” operation, and it is accomplished through a mechanism referred to as Inter Portlet Communication (IPC).

Existing solutions and specifications related to the IPC have several limitations. For example, the Java Specification Request 286 (JSR286) Java Community specification covers several aspects of the IPC, but it focuses on communication that occurs on the server side, in which communication between portlets requires several round trips to the portal application server that renders the portlets. Other proprietary IPC mechanisms support client side IPC, but they are very rigid, or static. Such proprietary IPC mechanisms, for instance, operate under the assumption that communication is always made on predefined events that are well known to the communicating portlets, and thereby cannot be dynamically modified or enriched—i.e., without code changes.

### SUMMARY

Systems, methods and media for providing client-side interportlet communication are provided. The disclosed subject matter provides architecture and mechanisms for token-based client-side interportlet communication. The disclosed subject matter does not require a portlet developer to know in advance all the possible tokens to which a portlet should be able to respond, because it provides a dynamic definition of interportlet communication behaviors at the portal page level that portlets can adapt to without the need of code changes.

In one embodiment, a method for providing client-side interportlet communication is provided. The method includes executing an event manager, generated at a portal server, on a client device hosting at least one portal page for providing interportlet communication to a plurality of portlets contained in the at least one portal page. The event manager module includes a definition for a set of behaviors associated with the at least one portal page, and each of the set of behaviors defines at least one action to be performed based on a set of published tokens and corresponding subscribed tokens. The method also includes receiving at the event manager module running on a client device a registration request from each of the plurality of portlets when the at least one portal page containing the plurality of portlets is first loaded at the client device. The registration request includes a first set of tokens that the respective portlet may publish and a second set of tokens that the respective portlet may receive as a part of inputs for callback actions. The method also includes receiving at the event manager module an event set off by one of the plurality of portlets. The event is defined by one or more tokens published by the one of the plurality of portlets. If the one or more tokens defining the event match the set of published tokens defined in one or more of the set of behaviors, the method further includes invoking at the event manager module a callback function of one or more of the plurality of portlets having at least one token in the respective second set of tokens that matches the corresponding subscribed tokens defined in the one or more of the set of behaviors.

In another embodiment, a system for providing client-side interportlet communication is provided. The system includes a processor and a memory that is coupled to the processor and capable of storing data. The processor is configured for using the data such that the system can host at least one portal page and run an event manager module that is generated at a portal server for the at least one portal page for providing interportlet communication to a plurality of portlets contained in the at least one portal page. The event manager module includes a definition for a set of behaviors associated with the at least one portal page, and each of the set of behaviors defines at least one action to be performed based on a set of published tokens and corresponding subscribed tokens. The processor is also configured for using the data such that the system can receive at the event manager module a registration request from each of the plurality of portlets when the at least one portal page containing the plurality of portlets is first loaded. The registration request includes a first set of tokens that the respective portlet may publish and a second set of tokens that the respective portlet may receive as a part of inputs for callback actions. The processor is also configured for using the data such that the system can receive at the event manager module an event set off by one of the plurality of portlets wherein the event is defined by one or more tokens published by the one of the plurality of portlets. If the one or more tokens defining the event match the set of published tokens defined in one or more of the set of behaviors, the processor is also configured to use the data such that the system can invoke at the event manager module a callback function of one or more of the plurality of portlets having at least one token in the respective second set of tokens that matches the corresponding subscribed tokens defined in the one or more of the set of behaviors.

In another embodiment, logic encoded in one or more tangible media storing computer code for execution is provided. The computer code, when executed by a processor, is operable to perform operations that include executing an event manager, generated at a portal server, on a client device hosting at least one portal page for providing interportlet communication to a plurality of portlets contained in the at least one portal page. The event manager module includes a definition for a set of behaviors associated with the at least one portal page, and each of the set of behaviors defines at least one action to be performed based on a set of published tokens and corresponding subscribed tokens. The operations also include receiving at the event manager module running on a client device a registration request from each of the plurality of portlets when the at least one portal page containing the plurality of portlets is first loaded at the client device. The registration request includes a first set of tokens that the respective portlet may publish and a second set of tokens that the respective portlet may receive as a part of inputs for callback actions. The operations also include receiving at the event manager module an event set off by one of the plurality of portlets wherein the event is defined by one or more tokens published by the one of the plurality of portlets. If the one or more tokens defining the event match the set of published tokens defined in one or more of the set of behaviors, the operations further include invoking at the event manager module a callback function of one or more of the plurality of portlets having at least one token in the respective second set of tokens that matches the corresponding subscribed tokens defined in the one or more of the set of behaviors.

### BRIEF DESCRIPTION OF THE DRAWINGS

FIG. 1 is an illustrative diagram showing a system for providing client-side interportlet communication in accordance with some embodiments of the disclosed subject matter.

FIG. 2 is a diagram showing a process for providing client-side interportlet communication in accordance with some embodiments of the disclosed subject matter.

FIGS. 3A-B are illustrative diagrams showing instances of interportlet communication in accordance with some embodiments of the disclosed subject matter.

FIG. 4A is an illustrative diagram showing a main page for configuring behaviors associated with a portal page in accordance with some embodiments of the disclosed subject matter.

FIGS. 4B-F are illustrative diagrams showing configuration pages for updating behaviors related to a portal page in accordance with some embodiments of the disclosed subject matter.

### DETAILED DESCRIPTION

Systems, methods and media for providing client-side interportlet communication are disclosed. The disclosed subject matter provides greater flexibility in creating a portal page containing multiple portlets that may need to communicate with one another or that need to provide navigations to different portal page(s). In one embodiment, for instance, the disclosed subject matter provides meta-information (a.k.a., metadata), such as token-based interportlet communication behaviors, that may be defined by a user. Tokens (e.g., published/subscribed tokens) are supported by each of multiple portlets included in a portal page. A behavior may be an entity that describes a notification action or a navigation action to be performed based on a set of published tokens which may be mapped to a set of tokens in one or more portlets subscribing to interportlet communication (IPC) events in the same portal page or different portal page(s). The meta-information enables client-side interportlet communication without having to tightly couple the multiple portlets to one another's terms and definitions.

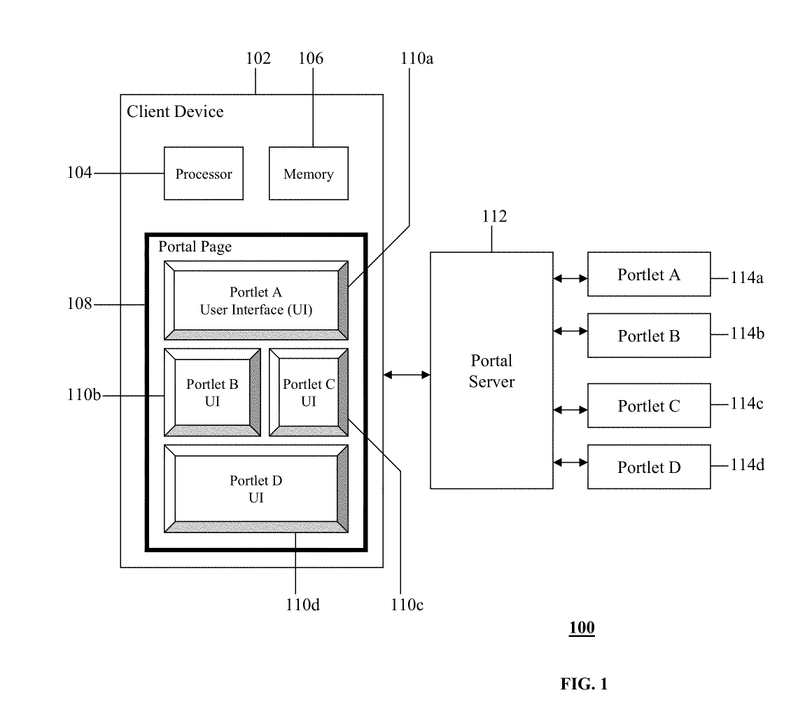

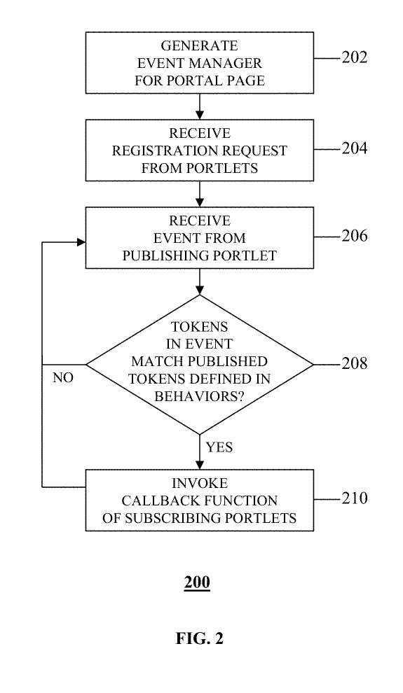

FIG. 1 is an illustrative diagram showing a system 100 for providing client-side interportlet communication in accordance with some embodiments of the disclosed subject matter. Referring to FIG. 1, system 100 includes a client device 102, a portal server 112, and a plurality of portlets 114a-d. Client device 102 in turn includes at least one processor 104 and memory 106 and is capable of instantiating and running at least one portal page 108. Portal page 108 can host plurality of portlets 114a-d.

Client device 102 may be any computing device that can run a web client, such as a web browser, and includes a server, a workstation, a desktop, a laptop, a palmtop, a personal data assistant (PDA), a smartphone, or a web-enabled mobile/portable device.

Processor 104 may be a general purpose processor, a special purpose processor, a digital signal processor, a multiprocessor core, a system-on-chip (SoC), or any digital controller capable of executing computer program instructions. Memory 106 may be a random access memory (RAM), such as static RAM (SRAM) or dynamic RAM (DRAM), a read only memory (ROM), or a writeable ROM, such as electrically erasable programmable ROM (EEPROM) or flash memory.

A web portal, or a portal, may be a web based application that can provide content aggregation from different sources. Content aggregation is the action of integrating content from different sources within a web page, referred to as a portal page. A portal may run on a portal server, such as portal server 112. A portal page, such as portal page 108, can function as a point of access to information available through the world wide web (Web). A portal page can include a different set of portlets for displaying content to different users. The portlet content can be presented to users through portlet user interfaces, such as portlet UIs 110a-d.

A portlet, such as portlet A 114a, B 114b, C 114c, or D 114d, may be a part of an application that provides specific content (e.g., information or service) to be included as a part of a portal page, such as portal page 108. Portlets can be used by portals as pluggable user interface components that can provide a presentation layer to information systems. The content of a portlet can be aggregated with the content of other portlets to form a portal page.

A portlet user interface, such as portlet UIs 110a, 110b, 110c, or 110d, can define a distinct runtime view of the specific content associated with a portlet, and may be assigned by a portal a unique ID that is constant and valid for the lifetime of the portlet.

FIG. 2 is a diagram showing a process 200 for providing client-side interportlet communication in accordance with some embodiments of the disclosed subject matter. Referring to FIG. 2, an event manager is generated at a portal server for a portal page, such as portal page 108, at 202. In one embodiment, an event manager is a JavaScript that can handle event publishing and subscribing. For example, the JavaScript based event manager can provide application programming interfaces (APIs) for portlets, such as portlets 114a-d, to register as a publisher, a subscriber or both, to publish and/or to receive a notification about events (e.g., one or more tokens). The event manager can act as a clearing house for managing all interportlet communication events and invoking the callback functions of subscribing portlets based on the matches between published and subscribed tokens defined by the portal page behaviors.

In one embodiment, the event manager for a portal page can be generated using a definition of a set of interportlet behaviors that is retrieved from a database located at a portal server. For example, the event manager, when generated, may be built to contain data structures for holding a list of persisted behaviors specific to a portal page retrieved from a database. A behavior may be an entity that describes a notification action or a navigation action to be performed based on a set of published tokens which may be mapped to a set of tokens in one or more portlets subscribing to IPC events in the same portal page or different ones. When a portlet publishes an event including one or more tokens, for example, the event manager for the portal page may match the published tokens to the ones defined as triggers for all behaviors, and perform the proper notification actions or navigation actions.

In some embodiments, an option is provided for updating/configuring the portal page behaviors. The event manager may provide a configuration graphical user interface (GUI) for a user to update the portal page behaviors by adding, editing, or deleting one or more behaviors. The configuration GUI may also allow the user to view all existing behaviors or specify, update or change the properties (e.g., published tokens, subscribed tokens, actions) of the behaviors. In one embodiment, an event manager configuration portlet provides the configuration GUI for configuring the event manager, e.g., by adding, editing or deleting one or more behaviors. In one embodiment, the configuration GUI can be accessed only by users having the privilege to configure the event manager. In one embodiment, the users can configure/update behaviors of one or more portal pages without instantiating the event manager by directly accessing the database.

The event manager may also internally create an object for each of the behaviors defined for the current portal page. The behaviors in the database may be updated by modifying the behavior objects. In one embodiment, the modified behavior objects may be passed back to the database to modify the database table for the persistent behaviors—the event manager, however, must be re-loaded to ascertain that the behaviors are updated in the current portal page. In one embodiment, JavaScript Object Notation (JSON) and Asynchronous JavaScript And XML (AJAX) are used for passing the behavior objects back and forth between the event manager and a portal server, such as portal server 112.

At 204, the event manager may start receiving registration requests from portlets, such as portlets 114a-d. When a portlet is instantiated, it sends a registration request to the event manager. In one embodiment, the portlet invokes an API provided by the event manager for portlet registration, such as registerPortlet(portlet_id, subscribed Tokens, publishedTokens, callback) function, where the portlet_id parameter is a unique ID for the registering portlet, subscribed Tokens parameter is a list of tokens the portlet may receive as an input to a behavior action, publishedTokens parameter is a list of tokens the portlet may publish as a part of an event and callback parameter can be used to point to an optional function. In one embodiment, the event manager invokes the callback function when an event triggered by a specific portlet, which is referenced as a source by a portal page behavior, is published and the event contains a set of tokens which match the source tokens specified in the same page behavior.

The event manager can create a portlet object for each portlet that sends a registration request and add the portlet object to a list of registered portlets. In one embodiment, the event manager contains the list of registered portlets. The event manager can also maintain a handle to each registered portlet on a portal page and use the handles to manage interportlet communication. In one embodiment, the event manager performs cleanup tasks (e.g., releasing system resources, etc.) when a registered portlet is removed from a portal page.

At 206, the event manager receives event(s) from one or more publishing portlets. In one embodiment, the portlets wishing to communicate with other portlets residing in the same or different portal page publish events by invoking an API provided by the event manager for publishing an event, such as publish(portlet_id, tokens, values) function, where the portlet_id parameter may be the ID of the publishing portlet, the tokens parameter may be an array of token names (e.g., character strings) contained in an event, and the values parameter may contain a corresponding array of values for the tokens parameter. For example, if a user interacts with a portlet that provides a geographical map by, e.g., selecting a new city, the portlet may publish this interaction/change by specifying a mnemonic token name related to the selected geographic area (e.g., City_zipcode) and a value associated with the selected city (e.g., 00315) and invoking an appropriate API, such as publish function—e.g., publish(‘portlet_instance_{—}1.1’, [‘City _zipcode’], [‘00315‘’]).

At 208, the event manager scans the list of portal page behaviors to verify if the portlet setting off the event is defined as a source portlet in any of the behaviors and if the event tokens are specified as a part of the source tokens specified in the same behavior. If one or more matching behaviors are found, at 210 the event manager executes the actions associated with each matching behavior by either invoking the callback functions of the destination portlets, or by navigating to a different portal page specifying the set of source tokens as the interportlet communication context for the new portal page. Process 200 then returns to 206. In the event that no matching behaviors are found, process 200 simply returns to 206. In one embodiment, when an event is published by a publishing portlet, the event manager identifies all matching behaviors and performs the corresponding notification actions or navigation actions based on the behavior definition.

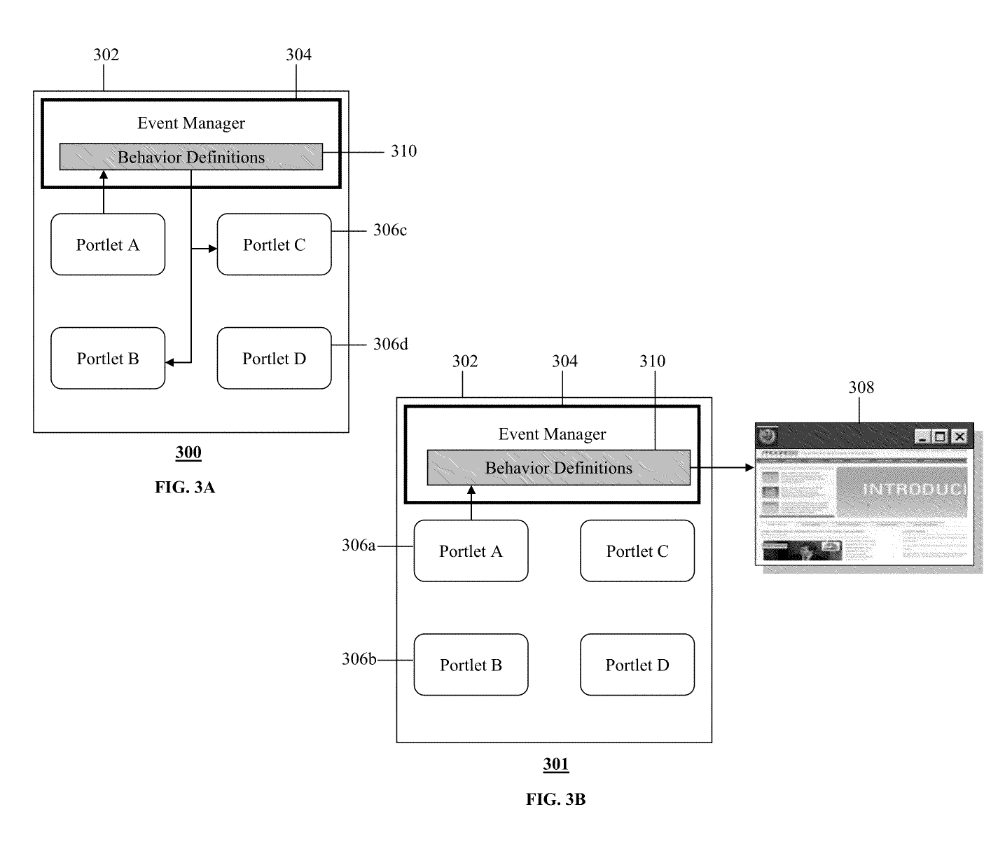

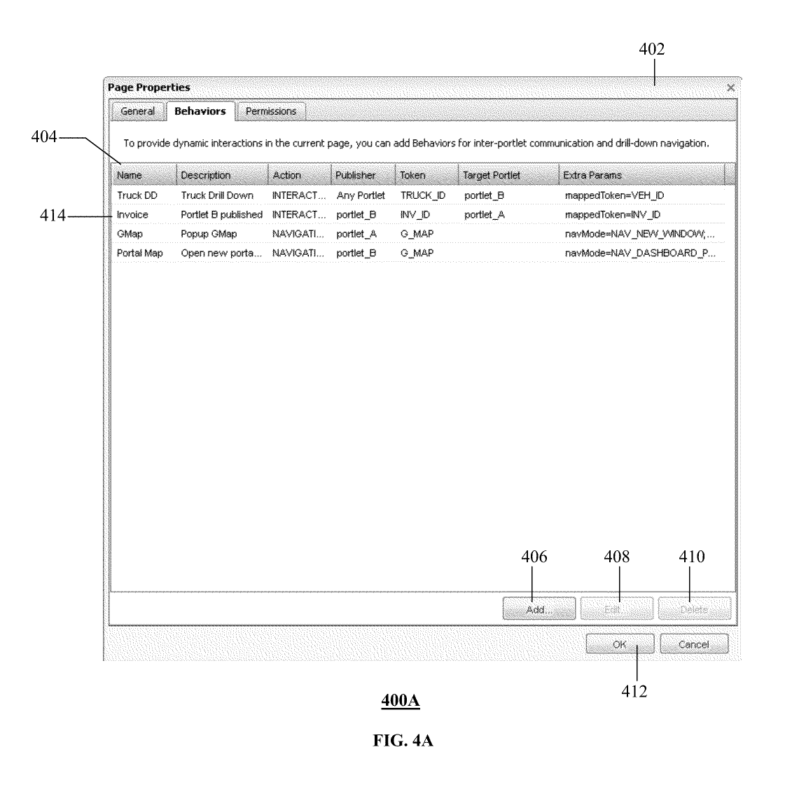

FIGS. 3A-B are illustrative diagrams 300, 301 showing instances of interportlet communication in accordance with some embodiments of the disclosed subject matter. Referring to FIG. 3A, a portal page 302 includes an event manager 304 and four registered portlets, portlet A 306a, portlet B 306b, portlet C 306c, and portlet D 306d. Event manager 304 also includes a definition of behaviors 310, including, e.g., as shown in FIG. 3A, a behavior that maps an event token triggered by Portlet A 306a to a notification actions targeting Portlet B 306b and Portlet C 306c.

For instance, when, as shown in FIG. 3A, a portlet (portlet A 306a) publishes an event including a token that matches the token property included in the definition of a particular behavior, the event manager identifies the destination portlets (portlets B and C 306b-c) from the destination property included in the definition of the behavior and invokes the corresponding callback function(s). However, portlet D 306d is not called back as a part of this event because no matching behaviors reference portlet D 306d as a target/destination portlet for the triggered event. In one embodiment, event manager 304 is a JavaScript that resides on the topmost frame of portal page 302.

Referring to FIG. 3B, portlet A 306a publishes an event including a token, e.g. docID, that specifies a particular external Web document. For example, a behavior is defined for portal page 302 for associating portlet A 306a and the token docID with a navigational action to a URL that is parameterized with the value of the docID token. Event manager 304 navigates to a window 308, which may be, based on the configuration of the behavior, a new window, a named window, or the same window where the web portal is currently displayed. Window 308 displays the Web document associated with the parameterized URL.

In one embodiment, the navigated page is another portal page associated with an interportlet communication context which contains the value of the docID token. In one embodiment, the APIs provided by event manager 304 can be accessed through a static singleton object to retrieve such interportlet communication context. If a portlet is hosted within an iFrame of portal page 302, this particular portlet may access the static instance of the singleton object by referencing the object's parent.

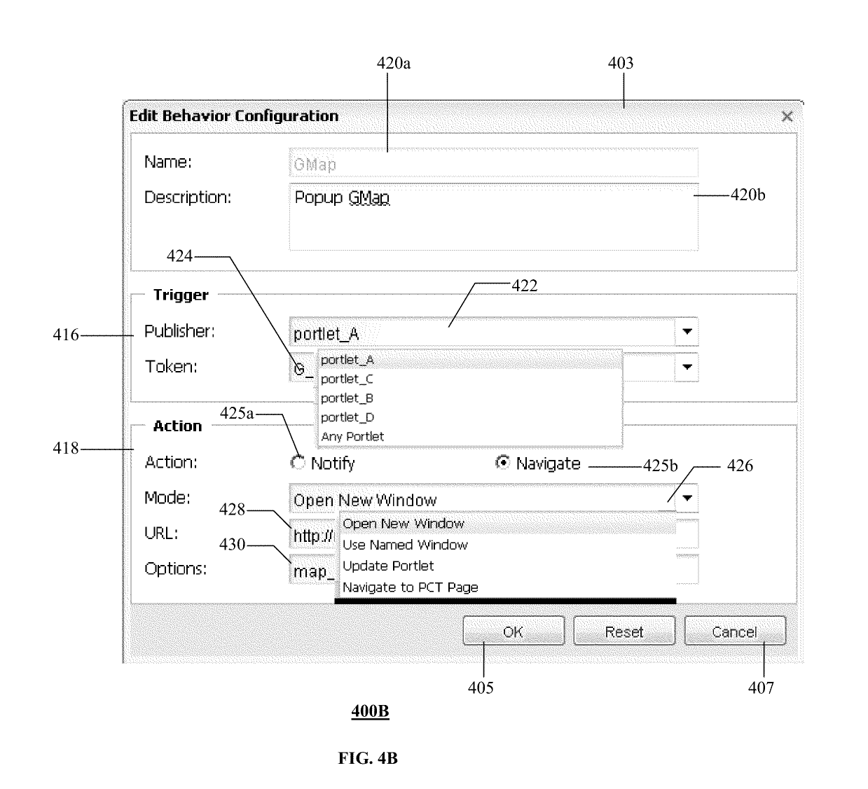

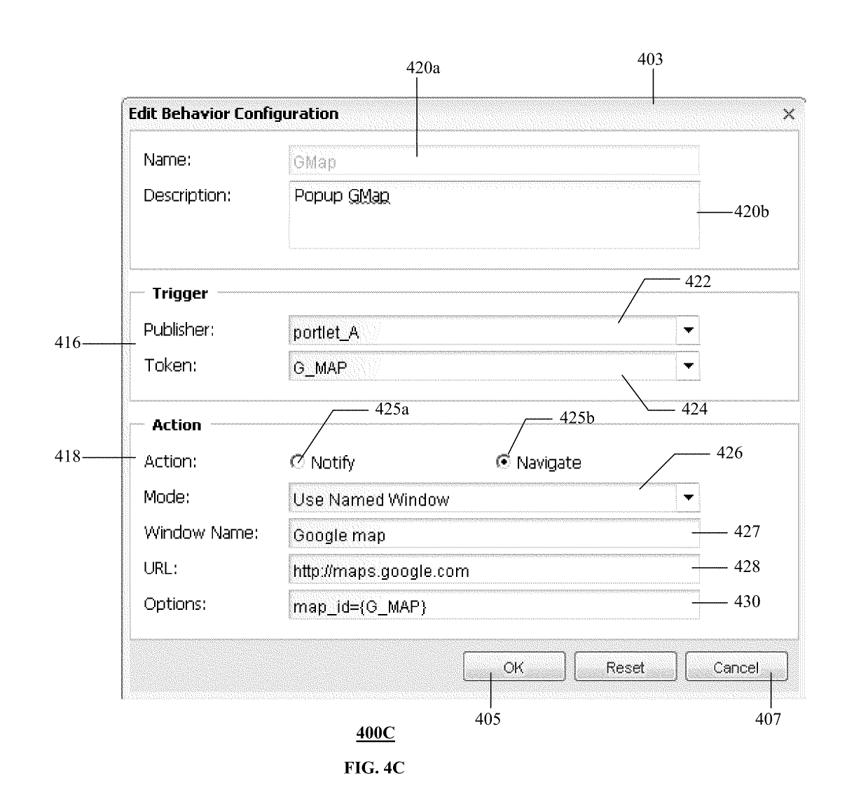

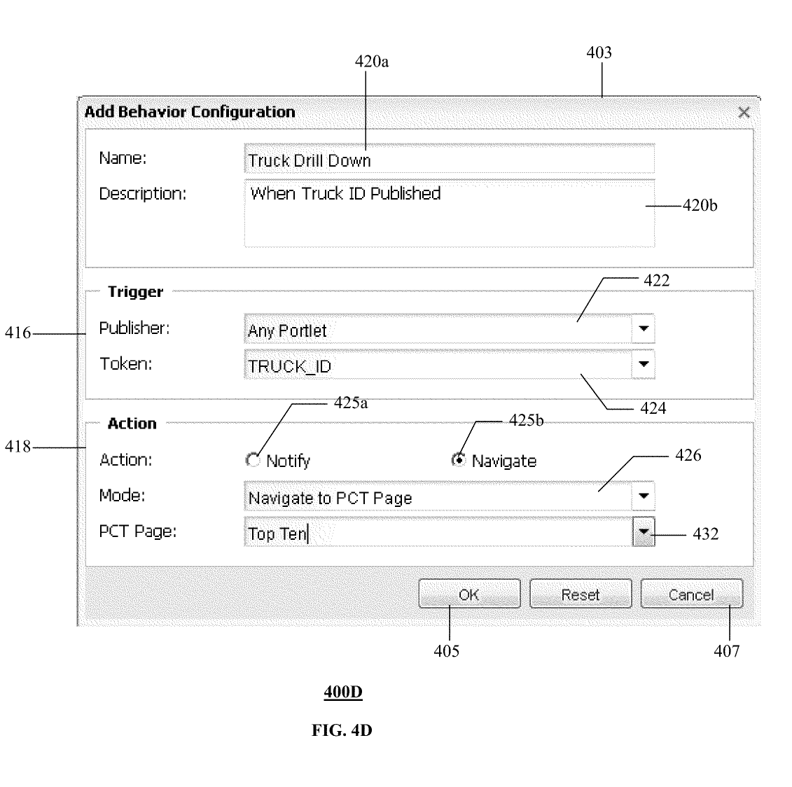

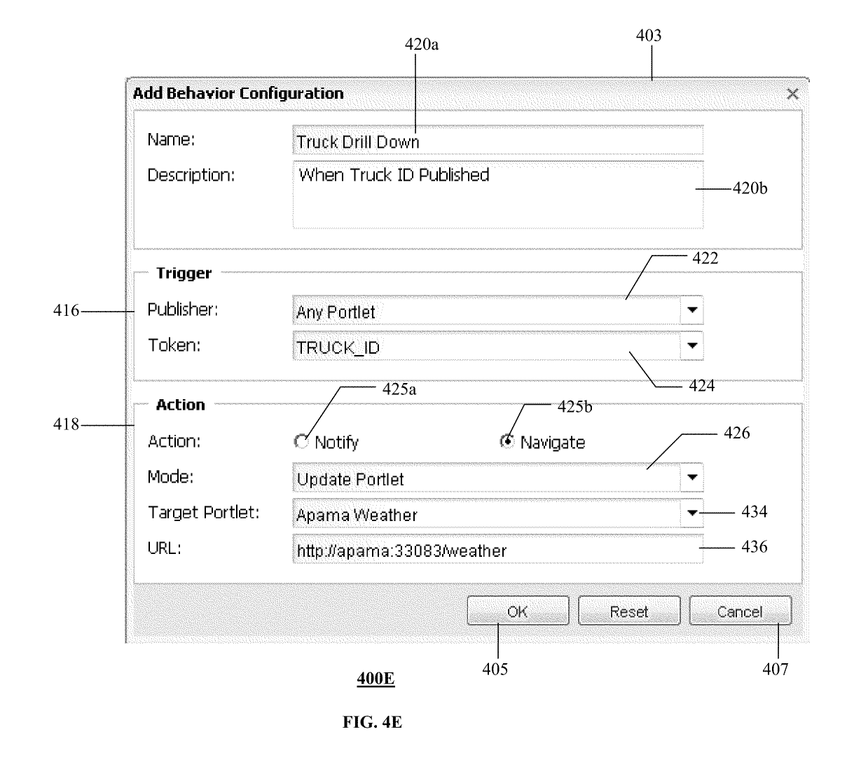

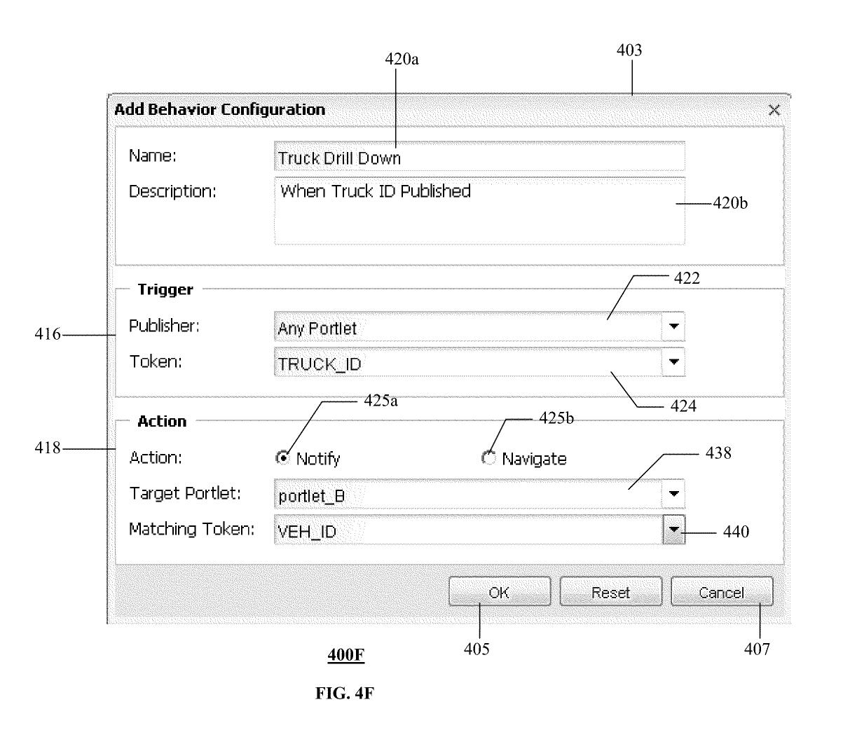

FIG. 4A is an illustrative diagram 400A showing a main configuration page for configuring behaviors associated with a portal page in accordance with some embodiments of the disclosed subject matter. Referring to FIG. 4A, behaviors of a portal page may be configured/updated through a configuration GUI, which may be provided to users who hold privileges to perform such task. Main page 402 of the configuration GUI includes a table 404 that contains all defined behaviors of a portal page, an ADD button 406, an EDIT button 408, a DELETE button 410, and an OK button 412.

Table 404 may include one or more rows, each of which displays a summary of a defined behavior, such as behavior 414. Behaviors' properties are enumerated in a set of columns, each of which represents a parameter of each defined behavior, such as the name, description and type of the behavior as well as the source portlet, tokens, and other information associated with the behavior.

To add a new behavior to the portal page, a user may click ADD button 406 and provide information associated with the new behavior. To edit or delete an existing behavior, the user may select a row containing a particular behavior and click EDIT button 408 or DELETE button 410. To exit the configuration mode, the user may click OK button 412. In one embodiment, the changes made by the user are automatically saved when the user clicks OK button 412. In another embodiment, the user will be prompted with an option to save the changes or to exit the configuration mode without saving the changes.

FIGS. 4B-F are illustrative diagrams 400B-F showing configuration pages for updating behaviors associated with a portal page in accordance with some embodiments of the disclosed subject matter. Referring to FIG. 4B, a configuration page 403 is displayed when the user clicks ADD button 406 or EDIT button 408. Configuration page 403 includes a Name textbox 420a for the name of the selected behavior, a Description textbox 420b for describing the behavior, a Trigger section 416, an Action section 418, an OK button 405, and a CANCEL button 407. In one embodiment, if the user clicks OK button 405, the changes made by the user are automatically saved before configuration page 403 is closed. If the user clicks CANCEL button 407, however, configuration page 403 will be closed and the changes made by the user will be discarded.

Trigger section 416 includes a Name textbox 420a, a Description textbox 420b, a Publisher dropdown menu 422, and a Token dropdown menu 424. Action section 418 includes a Notify radio button 425a and a Navigate radio button 425b. When the user selects Navigational radio button 425b, Action section 418 further displays a Mode dropdown menu 426, a URL textbox 428, and an Options textbox 430.

A behavior, such as behavior 414, may be identified by a name. In one embodiment, the name of each behavior is unique for each portal page and the uniqueness is enforced, e.g., by the configuration GUI. The user may add or modify the name of a new or existing behavior in Name textbox 420a. The user may also add or modify the description of a new or existing behavior in Description textbox 420b. In one embodiment, the description of a behavior is any string that describes the behavior.

The user may specify or modify the publishing portlet and a token that may be included in a published event. The publishing portlet and token may be specified or modified using Publisher dropdown menu 422 and Token dropdown menu 424, respectively. The Publishing dropdown menu may include a list of some or all of the registered portlets as well as a wild card (“Any Portlet”), which is used to indicate “any registered portlet.”

Trigger section 416 contains information describing the condition that, when satisfied, triggers a specified action associated with each behavior. For instance, the Publisher of behavior 414 (shown in FIG. 4A) is “Portlet B” and the Token that portlet B 306b publishes is “INV_ID.” Therefore, the condition for behavior 414, referred to as “Invoice,” may be interpreted as “when portlet B publishes INV_ID token.”

Action section 418 contains information that is related to the action associated with each behavior and describes what happens when the specified condition is satisfied. In one embodiment, there are two types of Action. One is Navigational action and the other is Notify-Portlet, or Interactive, action. The user can specify for a Navigational action or a Notify-Portlet action by selecting Notify radio button 425a or Navigate radio button 425b, respectively.

Having selected Navigational radio button 425b, the user can further select or modify one of several modes supported by the Navigational action using Mode dropdown menu 426. In one embodiment, the Navigational action includes four different modes: Open New Window mode, Use Named Window mode, Update Portlet mode, and Navigate to PCT Page mode. The user can also specify the URL of, e.g., the web site to be displayed on a new, or named, browser window and particular window style(s) (e.g., length, width, modal or non-modal, etc.) to be used when showing the browser window, using URL textbox 428 and Features textbox 430, respectively.

FIG. 4B shows configuration page 403 when the Open New Window mode is selected. Under the Open New Window mode, Navigational action can cause a new browser window, such as browser window 308 (shown in FIG. 3B), to open every time the action is triggered. In one embodiment, the window ID of the dashboard page (i.e., portal page) is appended to the selected URL as a parameter such that the web page displayed on the new browser window can cross reference the originating window displaying the portal, or dashboard, page.

FIG. 4C shows configuration page 403 when the Use Named Window mode is selected. Under the Use Named Window mode, a named window is re-used to display the web site specified by the URL. The user may specify the name of the re-used window using a Window Name textbox 427. For example, as shown in FIG. 4C, a window named “Google map” will be re-used to display a Google map web site “http://maps.google.com” when portlet_A publishes a navigational event including a matching token “G_MAP.”

In one embodiment, the URL in URL textbox 428 for a navigational behavior can specify one or more tokens. In one embodiment, all tokens specified in URL textbox 428 are replaced by the values of the published token before navigating to the web site associated with the URL. For example, if a navigational behavior includes “http://maps.google.com?city={city}” as the URL and a navigational event including a matching token “city” with a value, which is equal to “Tokyo,” is published, a new browser window may be opened using a modified URL, e.g., “http://maps.google.com?city=Tokyo.”

In one embodiment, the event manager, such as event manager 304, can provide a data conversion service. For example, if the navigational event that includes a different token (e.g., “locationInfo”), which is mapped to the city token, with a value equal to the GPS location (e.g., coordinates) of Tokyo instead of the name of the city, the event manager can convert the GPS location to the name of the city having the corresponding GPS coordinates.

FIG. 4D shows configuration page 403 when the Navigate to PCT Page (NTPP) mode is selected. Under the NTPP mode, the entire dashboard, or portal, page is replaced with a new portal page. The user can select from a Dashboard Page dropdown menu 432 a new dashboard page that can be used to replace the existing page. For example, as shown in FIG. 4D, the current portal page will be replaced with “Top Ten” page when any registered portlet publishes a navigational event including a matching token “TRUCK_ID.”

FIG. 4E shows configuration page 403 when the Update Portlet mode is selected. Under the Update Portlet mode, a particular portlet's content is replaced with a different content. The user can specify a portlet, the content of which will be changed, and a new content for the specified portlet using a Target Portlet dropdown box 434 and URL textbox 436, respectively. For example, as shown in FIG. 4E, Apama Weather portlet's content will be changed to a content that can be found at “http://apama:33083/weather” when any registered portlet publishes a navigational event including a matching token “TRUCK_ID.”

FIG. 4F shows a configuration page when Notify-Portlet, or Interactive, action is selected. When the user selects Notify radio button 525a, Action section 418 further displays a Target Portlet dropdown menu 438 and Matching Token dropdown menu 440. In one embodiment, the portlet specified using Target Portlet dropdown menu 438 is notified when the condition associated with the action is satisfied. For example, as shown in FIG. 4F, portlet B will be notified with the TRUCK_ID token mapped to VEH_ID when any registered portlet (specified as “Any Portlet” in Publisher dropdown menu 422) publishes an event that includes TRUCK_ID token. For instance, a callback function of portlet B can be invoked by the event manager, such as event manager 304, with TRUCK_ID mapped to VEH_ID when any registered portlet publishes the event. By mapping TRUCK_ID token to VEH_ID, the value held by TRUCK_ID token is copied to VEH_ID and VEH_ID with the new value is passed to the callback function. In one embodiment, a token included in an interactive event identifies/notifies one or more parameters that have been changed.

In one embodiment, Matching Token dropdown menu 440 provides the user with an option to map one token to another token that is used for identical or similar purposes but defined under, e.g., a different name. Because a token defined by one portlet can be mapped to another token defined by a different portlet without updating either portlet, interportlet communication between the two portlets can be performed without having to tightly couple either portlet to the other portlet's terms and definitions.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for providing client-side interportlet communication, the method comprising:
executing an event manager, generated at a portal server, on a client device hosting at least one portal page for providing interportlet communication to a plurality of portlets contained in the at least one portal page, wherein the event manager module includes a definition for a set of behaviors associated with the at least one portal page and wherein each of the set of behaviors defines at least one action to be performed based on a set of published tokens and corresponding subscribed tokens;
receiving at the event manager module running on a client device a registration request from each of the plurality of portlets when the at least one portal page containing the plurality of portlets is first loaded at the client device, wherein the registration request includes a first set of tokens that the respective portlet may publish and a second set of tokens that the respective portlet may receive as a part of inputs for callback actions;
receiving at the event manager module an event set off by one of the plurality of portlets wherein the event is defined by one or more tokens published by the one of the plurality of portlets; and
if the one or more tokens defining the event match the set of published tokens defined in one or more of the set of behaviors, invoking at the event manager module a callback function of one or more of the plurality of portlets having at least one token in the respective second set of tokens that matches the corresponding subscribed tokens defined in the one or more of the set of behaviors.

2. The method of claim 1, wherein the event manager module comprises a JavaScript residing in the at least one portal page.

3. The method of claim 1, further comprising:
for each registered portlet,
generating at the event manager module a portlet object; and
adding the portlet object to a list for registered portlets.

4. The method of claim 1, further comprising retrieving at the portal server the definition of the set of behaviors from a database that is in communication with the portal server.

5. The method of claim 4, further comprising updating at the portal server the definition of the set of behaviors.

6. The method of claim 5, wherein the update of the definition of the set of behaviors is performed through a graphical user interface (GUI).

7. The method of claim 1, further comprising generating at the event manager module a behavior object for each of the set of behaviors.

8. A system for providing client-side interportlet communication, the system comprising:
a processor; and
a memory coupled to the processor and capable of storing data,
wherein the processor is configured for using the data such that the system can:
host at least one portal page;
run an event manager module that is generated at a portal server for the at least one portal page for providing interportlet communication to a plurality of portlets contained in the at least one portal page, wherein the event manager module includes a definition for a set of behaviors associated with the at least one portal page and wherein each of the set of behaviors defines at least one action to be performed based on a set of published tokens and corresponding subscribed tokens;
receive at the event manager module a registration request from each of the plurality of portlets when the at least one portal page containing the plurality of portlets is first loaded, wherein the registration request includes a first set of tokens that the respective portlet may publish and a second set of tokens that the respective portlet may receive as a part of inputs for callback actions;
receive at the event manager module an event set off by one of the plurality of portlets wherein the event is defined by one or more tokens published by the one of the plurality of portlets; and
if the one or more tokens defining the event match the set of published tokens defined in one or more of the set of behaviors, invoke at the event manager module a callback function of one or more of the plurality of portlets having at least one token in the respective second set of tokens that matches the corresponding subscribed tokens defined in the one or more of the set of behaviors.

9. The system of claim 8, wherein the event manager module comprises a JavaScript residing in the at least one portal page.

10. The system of claim 8, wherein the processor is further configured for using the data such that the system can, for each registered portlet:
generate at the event manager module a portlet object; and
add the portlet object to a list for registered portlets.

11. The system of claim 8, wherein the definition of the set of behaviors is retrieved from a database.

12. The system of claim 8, wherein the processor is further configured for using the data such that the system can generate at the even manager module a behavior object for each of the set of behaviors.

13. The system of claim 8, wherein each of the one or more tokens defining the event includes a pair of token name in a string and a corresponding data value.

14. Logic encoded in one or more tangible media storing computer code for execution that, when executed by a processor, is operable to perform operations comprising:
executing an event manager, generated at a portal server, on a client device hosting at least one portal page for providing interportlet communication to a plurality of portlets contained in the at least one portal page, wherein the event manager module includes a definition for a set of behaviors associated with the at least one portal page and wherein each of the set of behaviors defines at least one action to be performed based on a set of published tokens and corresponding subscribed tokens;
receiving at the event manager module running on a client device a registration request from each of the plurality of portlets when the at least one portal page containing the plurality of portlets is first loaded at the client device, wherein the registration request includes a first set of tokens that the respective portlet may publish and a second set of tokens that the respective portlet may receive as a part of inputs for callback actions;
receiving at the event manager module an event set off by one of the plurality of portlets wherein the event is defined by one or more tokens published by the one of the plurality of portlets; and
if the one or more tokens defining the event match the set of published tokens defined in one or more of the set of behaviors, invoking at the event manager module a callback function of one or more of the plurality of portlets having at least one token in the respective second set of tokens that matches the corresponding subscribed tokens defined in the one or more of the set of behaviors.

15. The logic of claim 14, wherein the event manager module comprises a JavaScript residing in the at least one portal page.

16. The logic of claim 14, further comprising:
for each registered portlet, operations of
generating at the event manager module a portlet object; and
adding the portlet object to a list for registered portlets.

17. The logic of claim 14, further comprising retrieving at the portal server the definition of the set of behaviors from a database that is in communication with the portal server.

18. The logic of claim 17, further comprising an operation of updating at the portal server the definition of the set of behaviors.

19. The logic of claim 18, wherein the update of the definition of the set of behaviors is performed through a graphical user interface (GUI).

20. The logic of claim 14, further comprising an operation of generating at the event manager module a behavior object for each of the set of behaviors.
